(19) United States
(12) Patent Application Publication
(10) Pub. No.: US 2006/0039233 A1
(43) Pub. Date: Feb. 23, 2006

(54) Admixture dispensing method

(75) Inventors: Stephen A. Farrington, University Heights, OH (US); Bruce J. Christensen, Shanghai (CN)

Correspondence Address: CURATOLO SIDOTI CO., LPA, 24500 CENTER RIDGE ROAD, SUITE 280, CLEVELAND, OH, 44145, US

(73) Assignee: Construction Research & Technology GmbH, Trostberg (DE)

(21) Appl. No.: 11/202,813

(22) Filed: Aug. 12, 2005

Related U.S. Application Data
(60) Provisional application No. 60/603,224, filed on Aug. 20, 2004.

(51) Int. Cl. B28C 7/04; C04B 24/00

(52) U.S. Cl. 366/8; 106/724

(57) ABSTRACT

An admixture dispensing method that dispenses a dispersant admixture raw material and other admixture raw materials to cementitious compositions based on performance characteristics such as compressive and flexural strength, slump, setting time, air content, finishability, and material or process variables such as temperature, cement type used, additives such as pozzolan, and water cement ratio desired. The method may use computer software algorithms or lookup tables to determine an adjustable ratio of admixture raw materials that when added to the cementitious composition produces the desired performance characteristics. The method may calculate non-linear dosage rates between polycarboxylate dispersant admixture raw materials used for water reduction and strength generation and defoamer admixture raw materials to determine the correct amount of each to generate the desired air content in a cementitious composition.

### CROSS REFERENCE TO RELATED APPLICATIONS

This application claims the benefit of the filing date of United States Provisional Application for U.S. patent Ser. No. 60/603,224 filed Aug. 20, 2004.

### BACKGROUND

As known in the art, an admixture is a functional material or composition, other than hydraulic cement, water, and aggregate, that is used as an ingredient of concrete or mortar and is added to the batch before or during its mixing. Admixtures are used to modify the properties of the concrete in such a way as to make it more suitable for a particular purpose or for economy. Thus, the major reasons for using admixtures are (1) to achieve certain structural improvements in the resulting cured concrete; (2) to improve the quality of concrete through the successive stages of mixing, transporting, placing, and curing during adverse weather or traffic conditions; (3) to overcome certain emergencies during concreting operations; and (4) to reduce the cost of concrete construction. In some instances, the desired result can only be achieved by the use of an admixture. In addition, using an admixture allows the employment of less expensive construction methods or designs and thereby offsets the costs of the admixture.

For example, in specific applications, it may be desirable to retard or delay the setting of concrete for a specific length of time. This can be accomplished by the addition of a retarding admixture to the concrete. By varying the amounts of a retarding admixture used in a batch, the setting of the concrete can be delayed for a selected time period. The amount of retarder needed varies with the temperature conditions of the cementitious mixture and the ambient temperature. The amount needed on a cool day early in the morning differs from the amount needed later as temperatures warm. It would therefore be advantageous to monitor temperature and performance to adjust the ratio of the retarder added to the mix based on mass of cement.

It has become common in the industry to formulate admixtures so as to combine two or more functional materials or compositions in a single solution or dispersion, for convenience of handling and ease of mixing, particularly when the various compositions affect the performance of the cementitious mixture or concrete product in a functionally dependent or in a synergistic manner.

However, it is now recognized that there is not necessarily a linear relationship between the amounts of the various components and the function or performance desired. For example, dispersants and defoamers have been commercially blended in a single admixture, in order for the defoamer to provide air control to compensate for the incidental air entraining performance of the dispersant in the cementitious mix. The amount of air control required, however, is not linearly related to the amount of dispersant that must be added to provide for its water reducing function. That is, if a double dose of dispersant is required for a particular cementitious mix for water reduction, the double dose of defoamer that would be typically provided in a preformulated admixture would not compensate for the amount of air control actually needed. Traditional admixture dispensing and usage therefore can today deliver only specific target performances, rather than the continuous range of concrete performance characteristics that are potentially possible.

Admixtures are commercially available as liquids, dispersions, and water-soluble solids or powders, and these can be added to the cementitious mixture as solids or ready-to-use liquids added at bulk blending stations, including ready-mix plants or pre-cast plants. The successful use of admixtures depends upon the accuracy with which they are prepared and batched. Batching means the weighing or volumetric measuring of the ingredients for a batch of either concrete or mortar and introducing them into the mixer. The amount of admixture added during batching must be carefully controlled. Inaccuracies in the amount of admixture added can significantly affect the properties and performance of the concrete being batched and even defeat the original purpose of including the admixture. The need for accuracy in measuring the amount of solid or even liquid admixture to be added to a batch is particularly acute where only a relatively small amount of admixture is required for the job.

Admixtures are currently delivered to concrete blending facilities by compartmentalized trucks, and the various admixtures are loaded into storage containers awaiting demand and dispensing into the mixing apparatus. A typical concrete blending plant may use up to six of the sixty or more admixture formulations available. The storage containers that would be required for sixty formulations would take up more space (i.e. real estate footprint) than is available at most blending facilities. Therefore, most plants utilize an average of five storage tanks or silos, and change out the admixture stored and dispensed on a seasonal or project demand basis. This leads to the potential for cross contamination of formulations and potentially unpredictable or non-uniform performance in the cementitious mix and concrete or mortar product.

It is therefore desirable to provide a method for the custom blending of admixture components at the mixing site in a manner that accurately provides desired performance characteristics to the cementitious mix or concrete or mortar product, while minimizing container space requirements.

### SUMMARY

A method is provided for supplying adjustable ratios of admixture raw materials to a cementitious composition to generate desired performance characteristics which comprises providing values for material and process variables related to the desired performance characteristics of the cementitious composition; calculating proportional amounts of at least two admixture raw materials required to provide the desired performance characteristics to the cementitious composition; wherein the respective amounts are optionally non-linearly related; and adjusting the ratio of the at least two admixture raw materials to be dispensed to the cementitious composition.

A method is provided for supplying adjustable ratios of admixture raw materials to a cementitious composition to generate desired performance characteristics which comprises providing values for material and process variables related to the desired performance characteristics of the cementitious composition; calculating proportional amounts of dispersant admixture raw material and at least one admixture raw material selected from set accelerators, set retarders, air-entraining agents, or defoamers required to provide the desired performance characteristics to the cementitious composition; wherein the respective amounts are optionally non-linearly related; adjusting the ratio of the dispersant admixture raw material and the at least one admixture raw material to be dispensed to the cementitious composition.

A method of controlling air entrainment and air content in cementitious compositions containing polycarboxylate dispersant admixture raw material is provided that comprises providing values for the desired air entrainment and air content in the cementitious composition; calculating the proportional amount of defoamer admixture raw material based on the amount of polycarboxylate dispersant admixture raw material to provide the desired values; wherein the respective amounts are optionally non-linearly related; and adjusting the proportional ratio of the defoamer admixture raw material and polycarboxylate dispersant admixture raw material to be dispensed to the cementitious composition.

### DETAILED DESCRIPTION

The admixture dispensing system provides a window of performance as compared to prior art systems which only deliver specific points of performance within that window. The system reduces the amount of space previously required to store admixture formulations in that (1) individual stores of combination admixture formulations are no longer required as the admixture formulation is formulated on demand according to desired performance characteristics using a limited number of admixture raw materials, and (2) the admixture formulations no longer have to be diluted with water for storage reasons, as many admixture formulations that contain multiple admixture raw materials do not store well if concentrated.

In the prior art, admixture raw materials were combined for convenience and ease of mixing either at the supplier's site or transported to the customer's site, particularly when the various admixture raw materials affected the performance of the cementitious composition in a synergistic manner. However, the appropriate amounts of admixture raw material are not always linearly related. Therefore, the pre-formulated admixture formulations, even with step-wise additions or deletions to the pre-formulated admixture, did not always supply the desired affect over varied performance conditions. The present admixture dispensing system improves upon the prior art as a software program calculates and doses out the proper amount of admixture raw material required on demand, even if the relationship is non-linear between a dispersant admixture raw material and another admixture raw material such as an accelerator, retarder, air entrainer, or defoamer, or between at least two admixture raw materials.

It should be noted that the use of “admixture raw material” is not meant to exclude components that are formulated with the admixture material that may affect the properties of an admixture solution such as pH, stability, or solubility. Therefore, the term “admixture raw material” can include components in addition to the chemical that provides the special effect to the cementitious composition and can include multiple components that are combined to provide the special effect, as is conventional in the art. “Admixture raw material” is distinguished from an admixture formulation that includes more than one admixture chemical that produces the desired effects, plus other compounds such as those needed to stabilize the formulation.

The admixture raw materials can be added to the cementitious composition at the mix plant or concrete plant. The addition of the admixture raw materials may be controlled by a processor, for example, as embodied in a computer, which runs a software program containing algorithms that calculates and adjusts the amount and ratio of admixture raw materials needed to generate the desired performance characteristics. This eliminates the need for many pre-made admixture mixes and allows the same or greater performance with a limited number of admixture raw materials. In one embodiment, about six (6) to about eight (8) admixture raw materials are used. By adjusting the optionally non-linearly proportional ratios of the admixture raw materials to the dispersant admixture raw material used to achieve the desired performance characteristics in a cementitious composition, a wide performance range can be achieved. In one embodiment, the software program can be run using an encrypted software key wherein the desired formulation is chosen and a corresponding key is selected. In another embodiment, when the desired performance is determined it will be entered into the computer and the software will calculate the amount of admixture raw materials to match the desired performance characteristics. A keypad or other input device may be operatively connected (i.e. wired or wireless) to the processor and used by the operator to enter in values such as the desired performance characteristics, material variables and process variables.

When the amounts of admixture raw material are calculated the operator may position the mixing tank or other suitable container underneath the outlets of the admixture raw material dispensing system or alternatively the outlets are moved toward the mixing tank. The calculated amounts of admixture raw material are then dispensed and contemporaneously or subsequently mixed into the cementitious composition. Any suitable dispensing apparatus known in the prior art can be used.

Currently, controlling air entrainment and air contents in concrete treated with dispersants, especially polycarboxylate dispersants, is difficult due to two main factors. First, the materials used to control air are typically not soluble in aqueous solutions, which complicates manufacture and delivery of a homogenous solution. Secondly, the required dosage rates of defoamers are not linearly related to the appropriate dispersant dosage rate. Therefore, in a formulated product, which requires a linear relationship between the dispersant and defoaming agent, universally optimized performance over the entire dosage range of dispersants is not easily achievable.

It has been discovered that dispensing the defoaming agent optionally non-linearly proportionally to the polycarboxylate dispersant solves the previously described problem. This method establishes an appropriate relationship between the polycarboxylate dispersant dosage rate and that of the defoamer depending upon the variable conditions of the batch and the desired air entrainment and air content of the cementitious composition. An algorithm that provides the real world performance of the defoamer and polycarboxylate dispersant comprises:
K₁X²+K₂X+K₃=Y
wherein:
X=dosage of dispersant;
Y=dosage of defoamer; and
K₁, K₂, and K₃=are calculated based on historical data for the specific combination of dispersant and defoamer. The formula may also be adjusted for the specific type of cement used.

The relationship may be calculated using a software program with the defoamer and dispersant dispensed optionally non-linearly proportionally according to the calculations. The use of a computer controlled dispenser that calculates and dispenses the defoamer and polycarboxylate dispersant may be transparent to the user.

In another embodiment when the information is entered into the computer such as desired performance characteristics, process and material variables, the processor calculates the correct amount of admixture raw materials to dispense based upon a predetermined chart or look-up table contained within the memory associated with the processor.

In one embodiment the desired performance characteristics may include the following: compressive and flexural strength (affects the level of a strength improvement raw material), slump, setting time (affects the amount of accelerator or retarder added) and finishability (flat work or cast in place—could be used to modify the level of a finishability enhancing raw material). The process variables may include temperature (affects the retardation, set, and early strength development and amount of retarder and accelerator added—for example, the cementitious composition would need a certain level of retarder in the night or morning, but as the day progresses and gets warmer the amount of retarder needed by the composition would increase), water cement ratio desired, and air content (could be used to modify the level of defoamer). Material variables may include cement type used and cement additives such as finely divided mineral admixtures, pozzolan and aggregate. The software would calculate the amounts of admixture raw materials using algorithms based on real world performance of the admixture raw materials and historical data of past mixes.

Some admixtures raw materials are used to modify the fluid properties of fresh concrete, mortar and grout, while others are used to modify hardened concrete, mortar, and grout. The various admixture raw materials used in the admixture dispensing method are materials that can be used in concrete, mortar or grout, for example, for one or more of the following purposes: to increase workability without increasing water content or to decrease the water content at the same workability; to control air content, to retard or accelerate the time of initial setting; to reduce or prevent settlement of the finished material or to create slight expansion thereof; to modify the rate and/or capacity for bleeding; to reduce segregation of constituent ingredients; to improve penetration and pumpability; to reduce the rate of slump loss; to retard or reduce heat evolution during early hardening; to accelerate the rate of strength development at early stages; to increase the strength of the finished material (compressive, tensile, or flexural); to increase durability or resistance to severe conditions of atmospheric exposure, including application of deicing salts; to decrease the capillary flow of water within the material; to decrease permeability of the material to liquids; to control expansion caused by the reaction of alkali with certain aggregate constituents; to produce cellular concrete; to increase the bonding of concrete to steel reinforcing elements; to increase the bonding between old and new concrete; to improve the impact resistance and abrasion resistance of finished materials; to inhibit the corrosion of embedded metal; to produce colored concrete or mortar; and to introduce natural or synthetic fibers to reinforce concrete.

Often, more than one admixture raw material is added within a preformulated admixture by conventional poured or pumped systems to the cementitious composition as it is being processed in a commercial concrete mixer. The admixture raw materials can be added to the cementitious composition directly and individually, or they can be added as a single admixture formulation wherein the admixture raw materials have first been mixed or blended into an admixture formulation comprising at least two admixture raw materials before addition to the cementitious composition.

In one embodiment the admixture dispensing method includes dispensing a dispersant and at least one admixture raw material selected from set accelerators, set retarders, air-entraining agents, and defoamers. The fresh cementitious composition, to which the admixture raw materials are introduced, is mixed for sufficient time to cause the admixture raw materials to be distributed relatively uniformly throughout the fresh concrete.

In another embodiment the admixture dispensing method includes at least two admixture raw materials that can be selected from, but are not limited to: set accelerators, set retarders, air-entraining agents, defoamers, alkali-reactivity reducers, bonding admixtures, dispersants, coloring admixtures, corrosion inhibitors, dampproofing admixtures, gas formers, permeability reducers, pumping aids, shrinkage compensation admixtures, fungicidal admixtures, germicidal admixtures, insecticidal admixtures, rheology modifying agents, finely divided mineral admixtures, pozzolans, aggregates, wetting agents, strength enhancing agents, water repellents, and any other concrete or mortar admixture or additive. The fresh cementitious composition, to which the admixture raw materials are introduced, is mixed for sufficient time to cause the admixture raw materials to be dispersed relatively uniformly throughout the fresh concrete.

Set accelerators are used to accelerate the setting and early strength development of concrete. A set accelerator that can be used with the admixture system can be, but is not limited to, a nitrate salt of an alkali metal, alkaline earth metal, or aluminum; a nitrite salt of an alkali metal, alkaline earth metal, or aluminum; a thiocyanate of an alkali metal, alkaline earth metal or aluminum; an alkanolamine; a thiosulfate of an alkali metal, alkaline earth metal, or aluminum; a hydroxide of an alkali metal, alkaline earth metal, or aluminum; a carboxylic acid salt of an alkali metal, alkaline earth metal, or aluminum (preferably calcium formate); a polyhydroxylalkylamine; a halide salt of an alkali metal or alkaline earth metal (preferably chloride), Examples of set accelerators that may be used in the present dispensing method include, but are not limited to, POZZOLITH® NC534, nonchloride type set accelerator and/or RHEOCRETE® CNI calcium nitrite-based corrosion inhibitor, both sold under the above trademarks by Degussa Admixtures Inc. of Cleveland, Ohio.

The salts of nitric acid have the general formula M(NO₃)ₐ where M is an alkali metal, or an alkaline earth metal or aluminum, and where a is 1 for alkali metal salts, 2 for alkaline earth salts, and 3 for aluminum salts. Nitric acid salts of Na, K, Mg, Ca and Al may be used.

Nitrite salts have the general formula M(NO₂)ₐ where M is an alkali metal, or an alkaline earth metal or aluminum, and where a is 1 for alkali metal salts, 2 for alkaline earth salts, and 3 for aluminum salts. Nitric acid salts of Na, K, Mg, Ca and Al may be used.

The salts of the thiocyanic acid have the general formula M(SCN)_{b}, where M is an alkali metal, or an alkaline earth metal or aluminum, and where b is 1 for alkali metal salts, 2 for alkaline earth salts and 3 for aluminum salts. These salts are variously known as sulfocyanates, sulfocyanides, rhodanates or rhodanide salts. Thiocyanic acid salts of Na, K, Mg, Ca and Al may be used.

Alkanolamine is a generic term for a group of compounds in which trivalent nitrogen is attached directly to a carbon atom of an alkyl alcohol. A representative formula is N[H]_{c}[(CH₂)_{d}CHRCH₂R]ₑ, where R is independently H or OH, c is 3-e, d is 0 to about 4 and e is 1 to about 3. Examples include, but are not limited to, are monoethanoalamine, diethanolamine, triethanolamine, and triisopropanolamine.

The thiosulfate salts have the general formula M_{f}(S₂O₃)_{g} where M is alkali metal or an alkaline earth metal or aluminum, and f is 1 or 2 and g is 1, 2 or 3, depending on the valencies of the M metal elements. Thiosulfate acid salts of Na, K, Mg, Ca and Al may be used.

The carboxylic acid salts have the general formula RCOOM wherein R is H or C₁ to about C₁₀ alkyl, and M is alkali metal or an alkaline earth metal or aluminum. Carboxylic acid salts of Na, K, Mg, Ca and Al may be used. A further carboxylic acid salt that may be used is calcium formate.

A preferred polyhydroxylalkylamine has the general formula 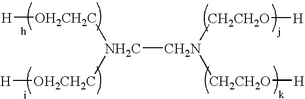
wherein h is 1 to 3, i is 1 to 3, j is 1 to 3, and k is 0 to 3. A polyhydroxyalkylamine that may be used is tetrahydroxyethylethylenediamine.

Set retarding, also known as delayed-setting or hydration control, admixtures are used to retard, delay, or slow the rate of setting of concrete. They can be added to the concrete mix upon initial batching or sometime after the hydration process has begun. Set retarders are used to offset the accelerating effect of hot weather on the setting of concrete, or delay the initial set of concrete or grout when difficult conditions of placement occur, or problems of delivery to the job site, or to allow time for special finishing processes. Most set retarders also act as low level water reducers and can also be used to entrain some air into concrete. Retarders that can be used include, but are not limited to an oxy-boron compound, corn syrup, lignin, a polyphosphonic acid, a carboxylic acid, a hydroxycarboxylic acid, polycarboxylic acid, hydroxylated carboxylic acid, such as fumaric, itaconic, malonic, borax, gluconic, and tartaric acid, lignosulfonates, ascorbic acid, isoascorbic acid, sulphonic acid-acrylic acid copolymer, and their corresponding salts, polyhydroxysilane, polyacrylamide, carbohydrates and mixtures thereof. Illustrative examples of retarders are set forth in U.S. Pat. Nos. 5,427,617 and 5,203,919, incorporated herein by reference. A further example of a retarder suitable for use in the admixture system is a hydration control admixture sold under the trademark DELVO® by Degussa Admixtures Inc. of Cleveland, Ohio.

The term air entrainer includes any chemical that will entrain air in cementitious compositions. Air entrainers can also reduce the surface tension of a composition at low concentration. Air-entraining admixtures are used to purposely entrain microscopic air bubbles into concrete. Air-entrainment dramatically improves the durability of concrete exposed to moisture during cycles of freezing and thawing. In addition, entrained air greatly improves concrete's resistance to surface scaling caused by chemical deicers. Air entrainment also increases the workability of fresh concrete while eliminating or reducing segregation and bleeding. Materials used to achieve these desired effects can be selected from wood resin, natural resin, synthetic resin, sulfonated lignin, petroleum acids, proteinaceous material, fatty acids, resinous acids, alkylbenzene sulfonates, sulfonated hydrocarbons, vinsol resin, anionic surfactants, cationic surfactants, nonionic surfactants, natural rosin, synthetic rosin, an inorganic air entrainer, synthetic detergents, and their corresponding salts, and mixtures thereof. Air entrainers are added in an amount to yield a desired level of air in a cementitious composition. Examples of air entrainers that can be utilized in the admixture system include, but are not limited to MB AE 90, MB VR and MICRO AIR®, all available from Degussa Admixtures Inc. of Cleveland, Ohio.

Defoamers are used to decrease the air content in the cementitious composition. Examples of defoamers that can be utilized in the cementitious composition include, but are not limited to mineral oils, vegetable oils, fatty acids, fatty acid esters, hydroxyl functional compounds, amides, phosphoric esters, metal soaps, silicones, polymers containing propylene oxide moieties, hydrocarbons, alkoxylated hydrocarbons, alkoxylated polyalkylene oxides, tributyl phosphates, dibutyl phthalates, octyl alcohols, water-insoluble esters of carbonic and boric acid, acetylenic diols, ethylene oxide-propylene oxide block copolymers and silicones.

The term dispersant as used throughout this specification includes polycarboxylate dispersants. The term dispersant is also meant to include those chemicals that also function as a plasticizer, water reducer, fluidizer, antiflocculating agent, or superplasticizer for cementitious compositions, such as lignosulfonates, salts of sulfonated naphthalene sulfonate condensate, and salts of sulfonated melamine sulfonate condensate.

Polycarboxylate dispersants can be used, by which is meant a dispersant having a carbon backbone with pendant side chains, wherein at least a portion of the side chains are attached to the backbone through a carboxyl group or an ether group. The term dispersant is also meant to include those chemicals that also function as a plasticizer, high range water reducer, fluidizer, antiflocculating agent, or superplasticizer for cementitious compositions. Examples of polycarboxylate dispersants can be found in U.S. Pub. No. 2002/0019459 A1, U.S. Pat. No. 6,267,814, U.S. Pat. No. 6,290,770, U.S. Pat. No. 6,310,143, U.S. Pat. No. 6,187,841, U.S. Pat. No. 5,158,996, U.S. Pat. No. 6,008,275, U.S. Pat. No. 6,136,950, U.S. Pat. No. 6,284,867, U.S. Pat. No. 5,609,681, U.S. Pat. No. 5,494,516; U.S. Pat. No. 5,674,929, U.S. Pat. No. 5,660,626, U.S. Pat. No. 5,668,195, U.S. Pat. No. 5,661,206, U.S. Pat. No. 5,358,566, U.S. Pat. No. 5,162,402, U.S. Pat. No. 5,798,425, U.S. Pat. No. 5,612,396, U.S. Pat. No. 6,063,184, and U.S. Pat. No. 5,912,284, U.S. Pat. No. 5,840,114, U.S. Pat. No. 5,753,744, U.S. Pat. No. 5,728,207, U.S. Pat. No. 5,725,657, U.S. Pat. No. 5,703,174, U.S. Pat. No. 5,665,158, U.S. Pat. No. 5,643,978, U.S. Pat. No. 5,633,298, U.S. Pat. No. 5,583,183, and U.S. Pat. No. 5,393,343, which are all incorporated herein by reference.

The polycarboxylate dispersants used in the system can be at least one of the dispersant formulas a) through j):
a) a dispersant of Formula (I): 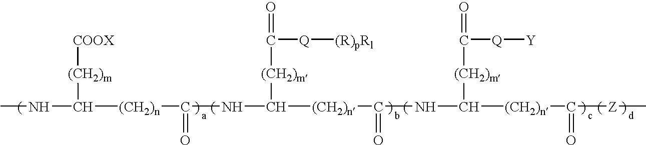
   wherein in Formula (I)
X is at least one of hydrogen, an alkali earth metal ion, an alkaline earth metal ion, ammonium ion, or amine;
R is at least one of C₁ to C₆ alkyl(ene) ether or mixtures thereof or C₁ to C₆ alkyl(ene) imine or mixtures thereof;
Q is at least one of oxygen, NH, or sulfur;
p is a number from 1 to about 300 resulting in at least one of a linear side chain or branched side chain;
R₁ is at least one of hydrogen, C₁ to C₂₀ hydrocarbon, or functionalized hydrocarbon containing at least one of —OH, —COOH, an ester or amide derivative of —COOH, sulfonic acid, an ester or amide derivative of sulfonic acid, amine, or epoxy;
Y is at least one of hydrogen, an alkali earth metal ion, an alkaline earth metal ion, ammonium ion, amine, a hydrophobic hydrocarbon or polyalkylene oxide moiety that functions as a defoamer;
m, m′, m″, n, n′, and n′ ′ are each independently 0 or an integer between 1 and about 20;
Z is a moiety containing at least one of i) at least one amine and one acid group, ii) two functional groups capable of incorporating into the backbone selected from the group consisting of dianhydrides, dialdehydes, and di-acid-chlorides, or iii) an imide residue; and
wherein a, b, c, and d reflect the mole fraction of each unit wherein the sum of a, b, c, and d equal one, wherein a, b, c, and d are each a value greater than or equal to zero and less than one, and at least two of a, b, c, and d are greater than zero;
b) a dispersant of Formula (II): 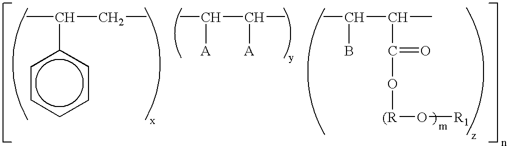
   wherein in Formula (II):
   A is COOM or optionally in the “y” structure an acid anhydride group (—CO—O—CO—) is formed in place of the A groups between the carbon atoms to which the A groups are bonded to form an anhydride;
   B is COOM
   M is hydrogen, a transition metal cation, the residue of a hydrophobic polyalkylene glycol or polysiloxane, an alkali metal ion, an alkaline earth metal ion, ferrous ion, aluminum ion, (alkanol)ammonium ion, or (alkyl)ammonium ion;
   R is a C₂₋₆ alkylene radical;
   R1 is a C₁₋₂₀ alkyl, C₆₋₉ cycloalkyl, or phenyl group;
   x, y, and z are a number from 0.01 to 100;
   m is a number from 1 to 100; and
   n is a number from 10 to 100;
c) a dispersant comprising at least one polymer or a salt thereof having the form of a copolymer of
   i) a maleic anhydride half-ester with a compound of the formula RO(AO)ₘH, wherein R is a C₁-C₂₀ alkyl group, A is a C₂₋₄ alkylene group, and m is an integer from 2-16; and
   ii) a monomer having the formula CH₂═CHCH₂—(OA)ₙOR, wherein n is an integer from 1-90 and R is a C₁₋₂₀ alkyl group;
d) a dispersant obtained by copolymerizing 5 to 98% by weight of an (alkoxy)polyalkylene glycol mono(meth)acrylic ester monomer (a) represented by the following general formula (1): 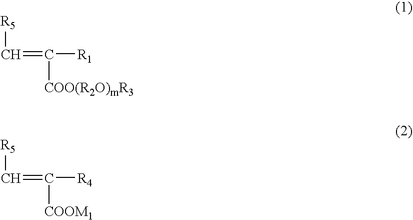
   wherein R₁ stands for hydrogen atom or a methyl group, R₂O for one species or a mixture of two or more species of oxyalkylene group of 2 to 4 carbon atoms, providing two or more species of the mixture may be added either in the form of a block or in a random form, R₃ for a hydrogen atom or an alkyl group of 1 to 5 carbon atoms, and m is a value indicating the average addition mol number of oxyalkylene groups that is an integer in the range of 1 to 100, 95 to 2% by weight of a (meth)acrylic acid monomer (b) represented by the above general formula (2), wherein R₄ and R₅ are each independently a hydrogen atom or a methyl group, and M₁ for a hydrogen atom, a monovalent metal atom, a divalent metal atom, an ammonium group, or an organic amine group, and 0 to 50% by weight of other monomer (c) copolymerizable with these monomers, provided that the total amount of (a), (b), and (c) is 100% by weight;
e) a graft polymer that is a polycarboxylic acid or a salt thereof, having side chains derived from at least one species selected from the group consisting of oligoalkyleneglycols, polyalcohols, polyoxyalkylene amines, and polyalkylene glycols;
f) a dispersant of Formula (III): 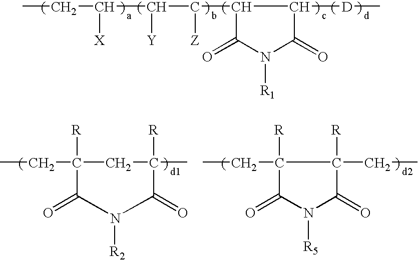
wherein in Formula (III):
D=a component selected from the group consisting of the structure d1, the structure d2, and mixtures thereof;
X=H, CH₃, C₂ to C₆ Alkyl, Phenyl, p-Methyl Phenyl, or Sulfonated Phenyl;
Y=H or —COOM;
R=H or CH₃;
Z=H, —SO3M, —PO₃M, —COOM, —O(CH₂)ₙOR₃ where n=2 to 6, —COOR₃, or —(CH₂)ₙOR₃ where n=0 to 6, —CONHR₃, —CONHC(CH₃)₂ CH₂SO3M, —COO(CHR₄)ₙOH where n=2 to 6, or —O(CH₂)ₙOR₄ wherein n=2 to 6;
R₁, R₂, R₃, R₅ are each independently —(CHRCH₂O)ₘR₄ random copolymer of oxyethylene units and oxypropylene units where m=10 to 500 and wherein the amount of oxyethylene in the random copolymer is from about 60% to 100% and the amount of oxypropylene in the random copolymer is from 0% to about 40%;
R₄=H, Methyl, C₂ to about C₆ Alkyl, or about C₆ to about C₁₀ aryl;
M=H, Alkali Metal, Alkaline Earth Metal, Ammonium, Amine, triethanol amine, Methyl, or C₂ to about C₆ Alkyl;
a=0 to about 0.8;
b=about 0.2 to about 1.0;
C=0 to about 0.5;
d=0 to about 0.5;
wherein a, b, c, and d represent the mole fraction of each unit and the sum of a, b, c, and d is 1.0;
wherein a can represent 2 or more differing components in the same dispersant structure;
wherein b can represent 2 or more differing components in the same dispersant structure;
wherein c can represent 2 or more differing components in the same dispersant structure; and
wherein d can represent 2 or more differing components in the same dispersant structure;
g) a dispersant of Formula (IV): 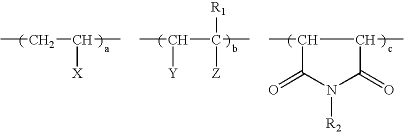
   wherein in Formula (IV):
   the “b” structure is one of a carboxylic acid monomer, an ethylenically unsaturated monomer, or maleic anhydride wherein an acid anhydride group (—CO—O—CO—) is formed in place of the groups Y and Z between the carbon atoms to which the groups Y and Z are bonded respectively, and the “b” structure must include at least one moiety with a pendant ester linkage and at least one moiety with a pendant amide linkage:
X=H, CH₃, C₂ to C₆ Alkyl, Phenyl, p-Methyl Phenyl, p-Ethyl Phenyl, Carboxylated Phenyl, or Sulfonated Phenyl;
Y=H, —COOM, —COOH, or W;
W=a hydrophobic defoamer represented by the formula R₅O—(CH₂CH₂O)ₛ—(CH₂C(CH₃)HO)ₜ—(CH₂CH₂O)ᵤ where s, t, and u are integers from 0 to 200 with the proviso that t>(s+u) and wherein the total amount of hydrophobic defoamer is present in an amount less than about 10% by weight of the polycarboxylate dispersant;
Z=H, —COOM, —O(CH₂)ₙOR₃ where n=2 to 6, —COOR₃, —(CH₂)ₙOR₃ where n=0 to 6, or —CONHR₃;
R₁=H, or CH₃;
R₂, R₃, are each independently a random copolymer of oxyethylene units and oxypropylene units of the general formula —(CH(R₁)CH₂O)ₘR₄ where m=10 to 500 and wherein the amount of oxyethylene in the random copolymer is from about 60% to 100% and the amount of oxypropylene in the random copolymer is from 0% to about 40%;
R₄=H, Methyl, or C₂ to C₈ Alkyl;
R₅=C₁ to C₁₋₈ alkyl or C₆ to C₁₋₈ alkyl aryl;
M=Alkali Metal, Alkaline Earth Metal, Ammonia, Amine, monoethanol amine, diethanol amine, triethanol amine, morpholine, imidazole;
a=0.01-0.8;
b=0.2-0.99;
c=0-0.5;
wherein a, b, c represent the mole fraction of each unit and the sum of a, b, and c, is 1;
wherein a can represent 2 or more differing components in the same dispersant structure; and
wherein c can represent 2 or more differing components in the same dispersant structure;
h) a random copolymer corresponding to the following Formula (V) in free acid or salt form having the following monomer units and numbers of monomer units: 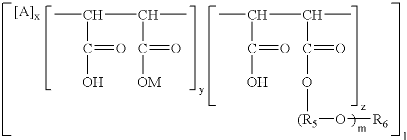
   wherein A is selected from the moieties (i) or (ii) 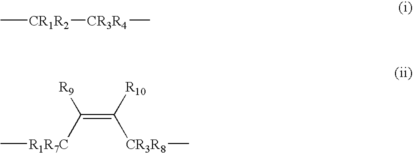
   wherein R₁ and R₃ are selected from substituted benzene, C₁₋₈ alkyl, C₂₋₈ alkenyl, C₂₋₈ alkylcarbonyl, C₁₋₈ alkoxy, carboxyl, hydrogen, and a ring, R₂ and R₄ are selected from the group consisting of hydrogen and C₁₋₄ alkyl, wherein R₁ and R₃ can together with R₂ and/or R₄ when R₁ and/or R₄ are C₁₋₄ alkyl form the ring;
   R₇, R₈, R₉, and R₁₀ are individually selected from the group consisting of hydrogen, C₁₋₆ alkyl, and a C₂₋₈ hydrocarbon chain, wherein R₁ and R₃ together with R₇ and/or R₈, R₉, and R₁₀ form the C₂₋₈ hydrocarbon chain joining the carbon atoms to which they are attached, the hydrocarbon chain optionally having at least one anionic group, wherein the at least one anionic group is optionally sulfonic;
   M is selected from the group consisting of hydrogen, and the residue of a hydrophobic polyalkylene glycol or a polysiloxane, with the proviso that when A is (ii) and M is the residue of a hydrophobic polyalkylene glycol, M must be different from the group —(R₅O)ₘR₆;
   R₅ is a C₂₋₈ alkylene radical;
   R₆ is selected from the group consisting of C₁₋₂₀ alkyl, C₆₋₉ cycloalkyl and phenyl;
   n, x, and z are numbers from 1 to 100;
   y is 0 to 100;
   m is 2 to 1000;
   the ratio of x to (y+z) is from 1:10 to 10:1 and the ratio of y:z is from 5:1 to 1:100;
i) a copolymer of oxyalkyleneglycol-alkenyl ethers and unsaturated mono and/or dicarboxylic acids, comprising:
   i) 0 to 90 mol % of at least one component of the formula 3a or 3b: 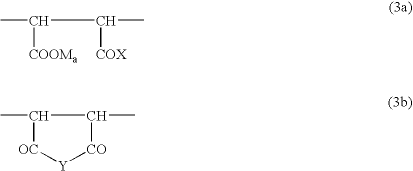
   wherein M is a hydrogen atom, a mono- or divalent metal cation, an ammonium ion or an organic amine residue, a is 1, or when M is a divalent metal cation a is ½; wherein X is —OMₐ,
      —O—(CₘH₂ₘO)ₙ—R¹ in which R¹ is a hydrogen atom, an aliphatic hydrocarbon radical containing from 1 to 20 carbon atoms, a cycloaliphatic hydrocarbon radical containing 5 to 8 carbon atoms or an optionally hydroxyl, carboxyl, C₁₋₁₄ alkyl, or sulphonic substituted aryl radical containing 6 to 14 carbon atoms, m is 2 to 4, and n is 0 to 100,
      —NHR₂, —N(R²)₂ or mixtures thereof in which R²=R¹ or —CO—NH₂; and
   wherein Y is an oxygen atom or —NR²;
   ii) 1 to 89 mol % of components of the general formula 4: 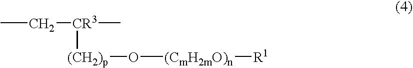
   wherein R₃ is a hydrogen atom or an aliphatic hydrocarbon radical containing from 1 to 5 carbon atoms, p is 0 to 3, and R₁ is hydrogen, an aliphatic hydrocarbon radical containing from 1 to 20 carbon atoms, a cycloaliphatic hydrocarbon radical containing 5 to 8 carbon atoms or an optionally hydroxyl, carboxyl, C₁₋₁₄ alkyl, or sulfonic substituted aryl radical containing 6 to 14 carbon atoms, m is independently 2 to 4, and n is 0 to 100, and
   iii) 0 to 10 mol % of at least one component of the formula 5a or 5b: 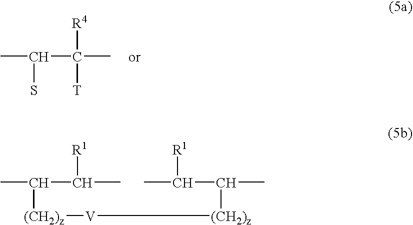
   wherein S is a hydrogen atom or —COOMₐ or —COOR₅, T is COOR₅, —W—R₇, —CO-[—NH—(CH₂)₃)-]s-W—R₇, —CO—O—(CH₂)_{z}—W—R₇, a radical of the general formula: 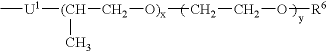
   or —(CH₂)_{z}—V—(CH₂)_{z}—CH═CH—R₁, or when S is —COOR₅ or —COOMₐ, U₁ is —CO—NHM-, —O— or —CH₂O, U2 is —NH—CO—, —O— or —OCH₂, V is —O—CO—C₆H₄—CO—O— or —W—, and W is 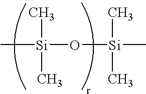
   R4 is a hydrogen atom or a methyl radical, R5 is an aliphatic hydrocarbon radical containing 3 to 20 carbon atoms, a cycloaliphatic hydrocarbon radical containing 5 to 8 carbon atoms or an aryl radical containing 6 to 14 carbon atoms, R₆=R₁ or 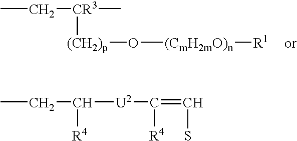
   R₇=R₁ or 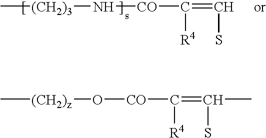
   r is 2 to 100, s is 1 or 2, x is 1 to 150, y is 0 to 15 and z is 0 to 4;
   iv) 0 to 90 mol % of at least one component of the formula 6a, 6b, or 6c: 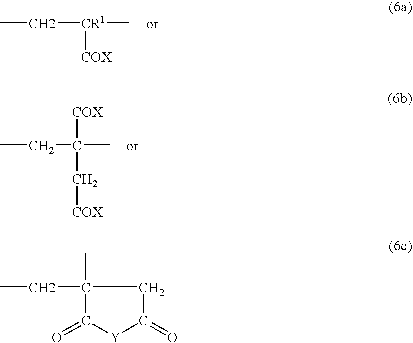
   wherein M is a hydrogen atom, a mono- or divalent metal cation, an ammonium ion or an organic amine residue, a is 1, or when M is a divalent metal cation a is ½; wherein X is —OMₐ,
      —O—(CₘH₂ₘO)ₙ—R¹ in which R¹ is a hydrogen atom, an aliphatic hydrocarbon radical containing from 1 to 20 carbon atoms, a cycloaliphatic hydrocarbon radical containing 5 to 8 carbon atoms or an optionally hydroxyl, carboxyl, C₁₋₁₄ alkyl, or sulphonic substituted aryl radical containing 6 to 14 carbon atoms, m is 2 to 4, and n is 0 to 100,
      —NH—(CₘH₂ₘO)ₙ—R¹,
      —NHR₂, —N(R²)₂ or mixtures thereof in which R²=R¹ or —CO—NH₂; and
   wherein Y is an oxygen atom or —NR²;
j) a copolymer of dicarboxylic acid derivatives and oxyalkylene glycol-alkenyl ethers, comprising:
   i) 1 to 90 mol. % of at least one member selected from the group consisting of structural units of formula 7a and formula 7b: 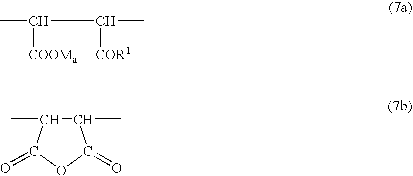
   wherein M is H, a monovalent metal cation, a divalent metal cation, an ammonium ion or an organic amine;
   a is ½ when M is a divalent metal cation or 1 when M is a monovalent metal cation;
   wherein R¹ is —OMₐ, or
      —O—(CₘH₂ₘO)ₙ—R² wherein R² is H, a C₁₋₂₀ aliphatic hydrocarbon, a C₅₋₈ cycloaliphatic hydrocarbon, or a C₆₋₁₄ aryl that is optionally substituted with at least one member selected from the group consisting of —COOMₐ, —(SO₃)Mₐ, and —(PO₃)Mₐ₂;
   m is 2 to 4;
   n is 1 to 200;
   ii) 0.5 to 80 mol. % of the structural units of formula 8: 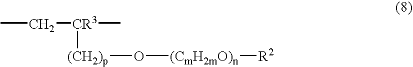
   wherein R³ is H or a C₁₋₅ aliphatic hydrocarbon;
   p is 0 to 3;
   R² is H, a C₁₋₂₀ aliphatic hydrocarbon, a C₅₋₈ cycloaliphatic hydrocarbon, or a C₆₋₁₄ aryl that is optionally substituted with at least one member selected from the group consisting of —COOMₐ, —(SO₃)Mₐ, and —(PO₃) Mₐ₂;
   m is 2 to 4;
   n is 1 to 200;
   iii) 0.5 to 80 mol. % structural units selected from the group consisting of formula 9a and formula 9b: 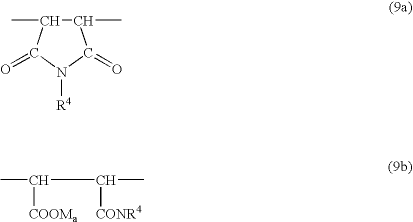
   wherein R⁴ is H, C₁₋₂₀ aliphatic hydrocarbon that is optionally substituted with at least one hydroxyl group, —(CₘH₂ₘO)ₙ—R², —CO—NH—R², C₅₋₈ cycloaliphatic hydrocarbon, or a C₆₋₁₄ aryl that is optionally substituted with at least one member selected from the group consisting of —COOMₐ, —(SO₃)Mₐ, and —(PO₃)Mₐ₂;
   M is H, a monovalent metal cation, a divalent metal cation, an ammonium ion or an organic amine;
   a is ½ when M is a divalent metal cation or 1 when M is a monovalent metal cation;
   R² is H, a C₁₋₂₀ aliphatic hydrocarbon, a C₅₋₈ cycloaliphatic hydrocarbon, or a C₆₋₁₄ aryl that is optionally substituted with at least one member selected from the group consisting of —COOMₐ, —(SO₃)Mₐ, and —(PO₃)Mₐ₂;
   m is 2 to 4;
   n is 1 to 200;
   iv) 1 to 90 mol. % of structural units of formula 10 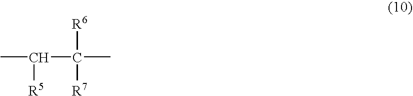
   wherein R⁵ is methyl, or methylene group, wherein R⁵ forms one or more 5 to 8 membered rings with R⁷;
   R⁶ is H, methyl, or ethyl;
   R⁷ is H, a C₁₋₂₀ aliphatic hydrocarbon, a C₆₋₁₄ aryl that is optionally substituted with at least one member selected from the group consisting of —COOMₐ, —(SO₃)Mₐ, and —(PO₃)Mₐ₂, a C₅₋₈ cycloaliphatic hydrocarbon, —OCOR⁴, —OR⁴, and —COOR⁴, wherein R⁴ is H, a C₁₋₂₀ aliphatic hydrocarbon that is optionally substituted with at least one —OH, —(CₘH₂ₘO)ₙ—R², —CO—NH—R², C₅₋₈ cycloaliphatic hydrocarbon, or a C₆₋₁₄ aryl residue that is optionally substituted with a member selected from the group consisting of —COOMₐ, —(SO₃)Mₐ, and —(PO₃)Mₐ₂;

In formula (e) the word “derived” does not refer to derivatives in general, but rather to any polycarboxylic acid/salt side chain derivatives of oligoalkyleneglycols, polyalcohols and polyalkylene glycols that are compatible with dispersant properties and do not destroy the graft polymer.

The substituents in the optionally substituted aryl radical of formula (i), containing 6 to 14 carbon atoms, may be hydroxyl, carboxyl, C₁₋₁₄ alkyl, or sulfonate groups.

The substituents in the substituted benzene may be hydroxyl, carboxyl, C₁₋₁₄ alkyl, or sulfonate groups.

Alkali reactivity reducers can reduce the alkali-aggregate reaction and limit the disruptive expansion forces that this reaction can produce in hardened concrete. The alkali-reactivity reducers include pozzolans (fly ash, silica fume), blast-furnace slag, salts of lithium and barium, and other air-entraining agents.

Natural and synthetic admixtures are used to color concrete for aesthetic and safety reasons. These coloring admixtures are usually composed of pigments and include carbon black, iron oxide, phthalocyanine, umber, chromium oxide, titanium oxide, cobalt blue, and organic coloring agents.

Corrosion inhibitors in concrete serve to protect embedded reinforcing steel from corrosion due to its highly alkaline nature. The high alkaline nature of the concrete causes a passive and noncorroding protective oxide film to form on the steel. However, carbonation or the presence of chloride ions from deicers or seawater can destroy or penetrate the film and result in corrosion. Corrosion-inhibiting admixtures chemically arrest this corrosion reaction. The materials most commonly used to inhibit corrosion are calcium nitrite, sodium nitrite, sodium benzoate, certain phosphates or fluorosilicates, fluoroaluminites, amines and related chemicals.

Dampproofing admixtures reduce the permeability of concrete that have low cement contents, high water-cement ratios, or a deficiency of fines in the aggregate. These admixtures retard moisture penetration into dry concrete and include certain soaps, stearates, and petroleum products.

Gas formers, or gas-forming agents, are sometimes added to concrete and grout in very small quantities to cause a slight expansion prior to hardening. The amount of expansion is dependent upon the amount of gas-forming material used and the temperature of the fresh mixture. Aluminum powder, resin soap and vegetable or animal glue, saponin or hydrolyzed protein can be used as gas formers.

Permeability reducers are used to reduce the rate at which water under pressure is transmitted through concrete. Silica fume, fly ash, ground slag, natural pozzolans, water reducers, and latex can be employed to decrease the permeability of the concrete. Pozzolan is a siliceous or siliceous and aluminous material, which in itself possesses little or no cementitious value. However, in finely divided form and in the presence of moisture, pozzolan will chemically react with calcium hydroxide at ordinary temperatures to form compounds possessing cementitious properties.

Rheology modifying agents can be used to increase the viscosity of cementitious compositions. Suitable examples of rheology modifier include fumed silica, colloidal silica, hydroxyethyl cellulose, hydroxypropyl cellulose, fly ash (as defined in ASTM C618), mineral oils (such as light naphthenic), hectorite clay, polyoxyalkylenes, polysaccharides, natural gums, or mixtures thereof.

The shrinkage compensation agent which can be used in the cementitious composition can include but is not limited to RO(AO)₁₋₁₀H, wherein R is a C₁₋₅ alkyl or C₅₋₆ cycloalkyl radical and A is a C₂₋₃ alkylene radical, alkali metal sulfate, alkaline earth metal sulfates, alkaline earth oxides, preferably sodium sulfate and calcium oxide. TETRAGUARD® is an example of a shrinkage reducing agent and is available from Degussa Admixtures Inc. of Cleveland, Ohio.

Bacteria and fungal growth on or in hardened concrete may be partially controlled through the use of fungicidal, germicidal, and insecticidal admixtures. The most effective materials for these purposes are polyhalogenated phenols, dialdrin emulsions, and copper compounds.

Fresh concrete can sometimes be harsh because of faulty mixture proportions or certain aggregate characteristics such as particle shape and improper grading. Under these conditions, entrained air which acts like a lubricant, can be used as a workability improving agent. Other workability agents are water reducers and certain finely divided admixtures.

Cementitious materials are materials that alone have hydraulic cementing properties, and set and harden in the presence of water. Included in cementitious materials are ground granulated blast-furnace slag, natural cement, hydraulic hydrated lime, and combinations of these and other materials.

The hydraulic cement can be a portland cement, a calcium aluminate cement, a magnesium phosphate cement, a magnesium potassium phosphate cement, a calcium sulfoaluminate cement or any other suitable hydraulic binder. Portland cement, as used in the trade, means a hydraulic cement produced by pulverizing clinker, comprising of hydraulic calcium silicates, calcium aluminates, and calcium ferroaluminates, with one or more of the forms of calcium sulfate as an interground addition. Portland cements according to ASTM C150 are classified as types I, II, III, IV, or V.

Finely divided mineral admixtures are materials in powder or pulverized form added to concrete before or during the mixing process to improve or change some of the plastic or hardened properties of portland cement concrete. The finely divided mineral admixtures can be classified according to their chemical or physical properties as: cementitious materials; pozzolans; pozzolanic and cementitious materials; and nominally inert materials.

A pozzolan is a siliceous or aluminosiliceous material that possesses little or no cementitious value but will, in the presence of water and in finely divided form, chemically react with the calcium hydroxide released by the hydration of portland cement to form materials with cementitious properties. Pozzolans can also be used to reduce the rate at which water under pressure is transferred through concrete. Diatomaceous earth, opaline cherts, clays, shales, fly ash, silica fume, volcanic tuffs and pumicites are some of the known pozzolans. Certain ground granulated blast-furnace slags and high calcium fly ashes possess both pozzolanic and cementitious properties. Nominally inert materials can also include finely divided raw quartz, dolomites, limestone, marble, granite, and others. Fly ash is defined in ASTM C618.

Aggregate can be included in the cementitious composition to provide for mortars which include fine aggregate, and concretes which also include coarse aggregate. The fine aggregate are materials that almost entirely pass through a Number 4 sieve (ASTM C 125 and ASTM C 33), such as silica sand. The coarse aggregate are materials that are predominantly retained on a Number 4 sieve (ASTM C 125 and ASTM C 33), such as silica, quartz, crushed round marble, glass spheres, granite, limestone, calcite, feldspar, alluvial sands, sands or any other durable aggregate, and mixtures thereof.

In the construction field, many methods of toughening concrete have been developed through the years. One modern method involves distributing fibers throughout a fresh concrete mixture. Upon hardening, this concrete is referred to as fiber-reinforced concrete. Fibers can be made of zirconia containing materials, steel, carbon, fiberglass, or synthetic materials, e.g., polypropylene, nylon, polyethylene, polyester, rayon, high-strength aramid, (i.e. Kevlar®), or mixtures thereof.

The admixture dispensing system provides a means for determining appropriate amounts of and introducing admixture raw materials and admixtures for concrete, mortar or grout into a cementitious composition. The cementitious composition may include a cement composition for the production of a concrete, mortar or grout; in certain embodiments a hydraulic cement, and in certain embodiments a portland cement.

In one embodiment the operator enters the desired performance characteristics such as air content, setting time, flexural strength, compressive strength, slump or finishability into the computer. The operator additionally assigns a value to process variables such as water cement ratio, ambient temperature, or air content, and material variables such as cement type or cement additive and enters them into the computer. Using software algorithms corresponding to real world material performance and/or predetermined chart or look-up table data contained within the memory of the processor, the computer calculates the amount of admixture raw materials required based on the operator's entry of the desired performance characteristics, process variables and material variables, and can initiate the dispensing of the correct amount of admixture raw materials.

In another embodiment, the operator selects a specific admixture formulation that exists in the memory of the computer and is comprised of two or more admixture raw materials available in the storage tanks on the site, and the computer calculates the amount of admixture raw materials that are required to produce the admixture formulation.

An experiment was conducted using a commercial polycarboxylate dispersant and a commercial defoaming agent, wherein a series of tests was run to determine the relationship between the amount of dispersant appropriate in a cementitious mixture and the amount of defoamer effective to control air in the mix. The test mixes studied and the results of the tests for estimated air content are set forth in Table 1 below.

TABLE 1

| | | | Air | | | Estimated |
|---|---|---|---|---|---|---|
| Sam- | CF, | PC | Entrainer, | Defoamer | | Air |
| ple | lb/yd³ | lb/cwt | oz/cwt | lb/cwt | W/(c + p) | Content % |
| 1 | 600 | 0.24 | 1.5 | 0.025 | 0.45 | 5.9 |
| 2 | 600 | 0.16 | 1.5 | 0.017 | 0.45 | 6.0 |
| 3 | 600 | 0.08 | 1.5 | 0.01 | 0.45 | 6.3 |
| 4 | 500 | 0.24 | 1 | 0.025 | 0.45 | 5.9 |
| 5 | 500 | 0.16 | 1 | 0.017 | 0.45 | 6.0 |
| 6 | 500 | 0.08 | 1 | 0.01 | 0.45 | 6.1 |
| 7 | 800 | 0.24 | 2.6 | 0.025 | 0.45 | 6.0 |
| 8 | 800 | 0.16 | 2.6 | 0.017 | 0.45 | 6.3 |
| 9 | 800 | 0.08 | 2.6 | 0.01 | 0.45 | 6.9 |
| 10 | 400 | 0.24 | 0.5 | 0.025 | 0.45 | 6.0 |
| 11 | 400 | 0.16 | 0.5 | 0.017 | 0.45 | 5.9 |
| 12 | 400 | 0.08 | 0.5 | 0.01 | 0.45 | 5.9 |
| 13 | 400 | 0.24 | 0.8 | 0.025 | 0.4 | 6.0 |
| 14 | 400 | 0.16 | 0.8 | 0.017 | 0.4 | 6.0 |
| 15 | 400 | 0.08 | 0.8 | 0.01 | 0.4 | 6.1 |
| 16 | 500 | 0.24 | 1.3 | 0.025 | 0.4 | 5.9 |
| 17 | 500 | 0.16 | 1.3 | 0.017 | 0.4 | 6.0 |
| 18 | 500 | 0.08 | 1.3 | 0.01 | 0.4 | 6.2 |

CF = Cement Factor
PC = Polycarboxylate dispersant
W/(c + p) = water cement ratio.

From the data analyzed, it was determined that the optimal dosage of defoamer to dispersant was based on a quadratic formula as follows:
Y=(K1)X²+(K2)X+(K3)
wherein:
X=dosage of dispersant;
Y=dosage of defoamer; and,
K₁, K₂, and K₃ are experimentally derived constants calculated based on historical data for the specific combination of dispersant and defoamer.

It will be understood that the embodiment(s) described herein is/are merely exemplary, and that one skilled in the art may make variations and modifications without departing from the spirit and scope of the invention. All such variations and modifications are intended to be included within the scope of the invention as described herein above. Further, all embodiments disclosed are not necessarily in the alternative, as various embodiments of the invention may be combined to provide the desired result.

We claim:

1. A method for supplying adjustable ratios of admixture raw materials to a cementitious composition to generate desired performance characteristics comprising:
a. providing values for material and process variables related to the desired performance characteristics of the cementitious composition;
b. calculating proportional amounts of at least two admixture raw materials required to provide the desired performance characteristics to the cementitious composition; wherein the respective amounts are optionally non-linearly related;
c. adjusting the ratio of the at least two admixture raw materials to be dispensed to the cementitious composition.

2. The method of claim 1 further comprising dispensing the at least two admixture raw materials to the cementitious composition according to the adjusted ratio.

3. The method of claim 2 further comprising monitoring the performance characteristics of the cementitious composition; and further adjusting the ratio of the at least two admixture raw materials.

4. The method of claim 1 wherein the at least two admixture raw materials are added to the cementitious composition by at least one of:
a. blending the at least two admixture raw materials into an admixture formulation before mixing with the cementitious composition; or
b. separately adding the at least two admixture raw materials to the cementitious composition.

5. The method of claim 2 wherein the at least two admixture raw materials are not diluted with water before being dispensed to the cementitious composition according to the adjusted ratio.

6. The method of claim 1 wherein the performance characteristics comprise at least one of flexural strength, compressive strength, slump, setting time or finishability.

7. The method of claim 1 wherein the material variables comprise at least one of cement type or cement additive.

8. The method of claim 1 wherein the process variables comprise at least one of ambient temperature, air content or water cement ratio.

9. The method of claim 1 wherein said calculating includes at least one of:
a. application of an algorithm to the variables by a processor; or
b. comparing the variables to data in predetermined charts or look up tables by a processor.

10. The method of claim 1 wherein the at least two admixture raw materials include about six to about eight admixture raw materials.

11. The method of claim 1 wherein the at least two admixture raw materials are at least one of set accelerators, set retarders, air-entraining agents, defoamers, alkali-reactivity reducer, bonding admixtures, polycarboxylate dispersants, coloring admixtures, corrosion inhibitors, dampproofing admixtures, grouting agents, gas formers, permeability reducers, pumping aids, shrinkage compensation admixtures, fungicidal admixtures, germicidal admixtures, insecticidal admixtures, rheology modifying agents, wetting agents, strength enhancing agents, water repellents, or mixtures thereof.

12. A method for supplying adjustable ratios of admixture raw materials to a cementitious composition to generate desired performance characteristics comprising:
a. providing values for material and process variables related to the desired performance characteristics of the cementitious composition;
b. calculating proportional amounts of dispersant admixture raw material and at least one admixture raw material selected from set accelerators, set retarders, air-entraining agents, or defoamers required to provide the desired performance characteristics to the cementitious composition; wherein the respective amounts are optionally non-linearly related;
c. adjusting the ratio of the dispersant admixture raw material and the at least one admixture raw material to be dispensed to the cementitious composition.

13. The method of claim 12 further comprising dispensing the dispersant admixture raw material and the at least one admixture component to the cementitious composition according to the adjusted ratio.

14. The method of claim 13 further comprising monitoring the performance characteristics of the cementitious composition; and further adjusting the ratio of the dispersant admixture raw material and the at least one admixture raw material.

15. The method of claim 12 wherein the dispersant admixture raw material and the at least one admixture raw material are added to the cementitious composition by at least one of:
a. blending the dispersant admixture raw material and the at least one admixture raw material into an admixture formulation before mixing with the cementitious composition; or
b. separately adding the dispersant admixture raw material and the at least one admixture raw material to the cementitious composition.

16. The method of claim 13 wherein the admixture raw materials are not diluted with water before being dispensed to the cementitious composition according to the adjusted ratio.

17. The method of claim 12 wherein the performance characteristics comprise at least one of flexural strength, compressive strength, slump, setting time or finishability.

18. The method of claim 12 wherein the material variables comprise at least one of cement type or cement additive.

19. The method of claim 12 wherein the process variables comprise at least one of ambient temperature, air content or water cement ratio.

20. The method of claim 12 wherein said calculating includes at least one of:
a. application of an algorithm to the variables by a processor; or
b. comparing the variables to data in predetermined charts or look up tables by a processor.

21. The method of claim 12 wherein the dispersant is a polycarboxylate dispersant represented by at least one of the dispersant formulas a) through j)

22. A method of controlling air entrainment and air content in cementitious compositions containing polycarboxylate dispersant admixture raw material comprising:
a. providing values for the desired air entrainment and air content in the cementitious composition;
b. calculating the proportional amount of defoamer admixture raw material based on the amount of the polycarboxylate dispersant admixture raw material to provide the desired values; wherein the respective amounts are optionally non-linearly related;
c. adjusting the proportional ratio of the defoamer admixture raw material and the polycarboxylate dispersant admixture raw material to be dispensed to the cementitious composition.

23. The method of claim 22 further comprising dispensing the defoamer admixture raw material and the polycarboxylate dispersant admixture raw material to the cementitious composition according to the adjusted proportional ratio.

24. The method of claim 22 including dispensing a polycarboxylate dispersant represented by at least one of the dispersant formulas a) through j).

25. The method of claim 23 further comprising monitoring the air entrainment and air content of the cementitious composition; and further adjusting the proportional ratio of the defoamer admixture raw material and the polycarboxylate dispersant admixture raw material.

26. The method of claim 22 wherein the defoamer admixture raw material and the polycarboxylate dispersant admixture raw material are added to the cementitious composition by at least one of:
a. blending the defoamer admixture raw material and the polycarboxylate dispersant admixture raw material into an admixture formulation before mixing with the cementitious composition; or
b. separately adding the defoamer admixture raw material and the polycarboxylate dispersant admixture raw material to the cementitious composition.

27. The method of claim 23 wherein the polycarboxylate dispersant admixture raw material and defoamer admixture raw material are not diluted with water before being dispensed to the cementitious composition according to the adjusted ratio.

28. The method of claim 22 wherein said calculating includes at least one of:
a. application of an algorithm to the variables by a processor; or
b. comparing the variables to data in predetermined charts or look up tables by a processor.
